(19) United States
(12) Patent Application Publication
(10) Pub. No.: US 2023/0202288 A1
(43) Pub. Date: Jun. 29, 2023

(54) CRAWLER VEHICLE, CONTROL METHOD AND COMPUTER PROGRAM OF SAID VEHICLE

(71) Applicant: PRINOTH S.P.A., Vipiteno (IT)

(72) Inventors: Martin Kirchmair, Vipiteno (IT); Alberto Paoletti, Vipiteno (IT)

(21) Appl. No.: 17/928,481

(22) PCT Filed: Jun. 4, 2021
(86) PCT No.: PCT/IB2021/054923

§ 371 Date: Nov. 29, 2022

(30) Foreign Application Priority Data
Jun. 5, 2020 (IT) 102020000013378

(51) Int. Cl. B60K 7/00; B60K 1/04; B60K 17/10

(52) U.S. Cl. CPC B60K 7/0015; B60K 1/04; B60K 17/10; B60Y 2200/25; B60Y 2200/252

(57) ABSTRACT

A crawler vehicle for the preparation of ski runs has a frame; a cabin mounted on the frame; a first and a second drive wheel driven by a first and a second hydraulic motor respectively; a battery assembly and an electric motor fed by the battery assembly, which are mounted on the frame behind the cabin and mainly under the cabin; and a power transmission assembly configured to transmit power from the electric motor to the hydraulic motors.

### TECHNICAL FIELD

The present disclosure relates to a crawler vehicle, in particular for the preparation of ski runs.

### BACKGROUND

Generally, a crawler vehicle comprises a frame; a cabin mounted on the frame; a propulsion system mounted on the frame; drive wheels actuated by the propulsion system; and tools powered by the propulsion system.

Typically, the propulsion system of the crawler vehicle comprises an internal combustion engine, a feed pump, a mechanical transmission configured to transmit power from the internal combustion engine to the feed pump, and hydraulic actuators, which are powered by the feed pump and are configured to drive the drive wheels and the tools. In this configuration, the internal combustion engine emits pollutant exhaust gases. A further drawback of certain crawler vehicles is relatively poor energy efficiency due to the relative difficulty of controlling the power output of the internal combustion engine so as to make the internal combustion engine work at the point of maximum efficiency regardless of the energy requirements of the crawler vehicle.

In recent decades, the increasing focus on reducing global pollution has led to the development of electric vehicles.

In general, the electric propulsion system allows relatively highly efficient energy transmission with zero emissions of pollutant gases, but it has the disadvantage of introducing structural imbalances in vehicles, with the consequent need to redesign the frame and the structural parts of the vehicle. As a result, the costs of designing and building vehicles with electric propulsion systems are relatively extremely high. Electric vehicles also place new demands on vehicle maintenance.

### SUMMARY

One purpose of the present disclosure is to provide a crawler vehicle, particularly for the preparation of ski runs which reduces certain of the drawbacks of certain of the prior art. In particular, one purpose of the present disclosure is to provide a crawler vehicle of the above type that is relatively environmentally friendly and is relatively simple and cheap to design, build and maintain.

According to the present disclosure, a crawler vehicle is made, in particular for the preparation of ski runs. The crawler vehicle comprising: a frame; a cabin mounted on the frame; a first and a second drive wheel driven by a first and a second hydraulic motor respectively; a battery assembly and an electric motor fed by the battery assembly, which are mounted on the frame behind the cabin and mainly under the cabin; and a power transmission assembly configured to transmit power from the electric motor to the hydraulic motors.

In accordance with the present disclosure, the power transmission is relatively highly efficient and with zero emissions of pollutant gases and, at the same time, the impact of the electric motor and the battery assembly on the structural characteristics of the crawler vehicle is relatively extremely limited. In this way, the frame developed for currently known internal combustion engine crawler vehicles can be used. As a result, the design costs of the frame of the crawler vehicle are reduced.

In particular, the arrangement of the electric motor and the battery assembly enable the center of gravity of the crawler vehicle to be kept relatively low in a manner similar to the internal combustion engine and the fuel tank, so as to optimize the performance of the crawler vehicle, particularly when the crawler vehicle is advancing along slopes. In addition, the power transmission assembly to the drive wheels does not present any particular maintenance problems.

In particular, the crawler vehicle comprises at least one tool connected in movable way to the frame and actuated by a respective further hydraulic motor. In this way, the at least one tool is powered by the electric motor via the power transmission assembly.

In particular, the power transmission assembly comprises a first pump hydraulically connected to the first hydraulic motor; a second pump hydraulically connected to the second hydraulic motor; at least a third pump hydraulically connected to the respective further hydraulic motor; and a mechanical transmission, which is arranged between the electric motor and the pumps and is configured to divide the power delivered by the electric motor between the pumps; the pumps being variable displacement pumps. In this way, each pump is powered by the electric motor and in turn supplies a respective hydraulic utility. In addition, based on the mechanical transmission, in use, the power delivered by the electric motor is divided between the pumps depending on the particular operating requirements, so as to reduce energy consumption and increase the operating life of the battery assembly.

In particular, the crawler vehicle comprises an auxiliary power supply assembly; in particular, a fuel cell or an internal combustion engine or a further battery assembly.

In greater detail, the auxiliary power supply assembly is configured to recharge the battery assembly and is removable from the crawler vehicle. This makes it possible, if necessary, to extend the duration of the crawler vehicle operations when the battery assembly is flat or drained.

In particular, the battery assembly is detachably coupled to the crawler vehicle, such as by a releasable coupling device, so as to facilitate replacement of the battery assembly and limit the downtime of the crawler vehicle. In other words, the flat battery assembly can be removed and replaced with another previously charged battery assembly, enabling the crawler vehicle to resume operations without the need to wait for the recharging time of the removed battery assembly.

In particular, the crawler vehicle comprises a control device configured to control the power delivered by the electric motor.

The control device is configured to independently control the speed of the electric motor and the displacement of the pumps to optimize the operating efficiency of the crawler vehicle. In this way, it is possible to vary both the speed of the electric motor and the displacement of the pumps, so as to work at the point of maximum efficiency of the pumps while at the same time guaranteeing the power supply of the hydraulic motors in specific operating requirements.

In particular, the control device is configured to acquire the speed of the electric motor and the displacement of the pumps; and to control the speed of the electric motor and the displacement of the pumps by respective closed loop controls depending respectively on the acquired speed of the electric motor and the acquired displacement of the pumps. In this way, the speed of the electric motor and the displacement of the pumps is adjusted relatively quickly and precisely.

In particular, the control device is configured to acquire a requested hydraulic power to each hydraulic motor; controlling the speed of the electric motor and/or the displacement of the respective pump to satisfy the requested hydraulic power; and acquiring the hydraulic power transmitted to each hydraulic motor. In this way, the energy efficiency of the crawler vehicle is further increased and the transmitted hydraulic power can be controlled via a first closed loop.

In particular, the control device is configured to acquire a requested running speed of the crawler vehicle; to control the speed of the electric motor and/or the displacement of the pumps to substantially match the requested running speed; and to acquire the running speed of the crawler vehicle. In this way, the running speed of the crawler vehicle can be relatively precisely controlled via a second closed loop.

In particular, the control device comprises a charge sensor configured to acquire the charge level of the battery assembly; the control device being configured to limit the power delivered by the electric motor when the acquired charge level falls below a predetermined threshold, so as to increase the operating duration of the crawler vehicle and/or enable the crawler vehicle to reach a charging station.

In particular, the control device is configured to calculate and provide a remaining operating time of the crawler vehicle based on the acquired charge level and on an expected average consumption of the crawler vehicle. In this way, the remaining operating time of the crawler vehicle can be estimated and an operator controlling the crawler vehicle can be informed.

In particular, the control device is configured to calculate and provide a maximum operating distance based on the acquired charge level, on an expected average consumption of the crawler vehicle and on at least one between the GPS position of the crawler vehicle, the snowpack characteristics of the ski slopes and the driving style of a crawler vehicle operator. In this way, the maximum operating distance of the crawler vehicle can be relatively accurately estimated.

A further purpose of the present disclosure is to provide a control method of the crawler vehicle that reduces certain of the drawbacks of certain of the prior art.

According to the present disclosure a method of controlling a crawler vehicle is provided; the crawler vehicle comprising a frame; two drive wheels driven by respective hydraulic motors; a battery assembly and an electric motor powered by the battery assembly; at least one tool connected to the frame and actuated by a respective further hydraulic motor; and a power transmission assembly comprising a plurality of variable displacement pumps and configured to transmit power from the electric motor to the hydraulic motors; the method comprising the steps of independently controlling the speed of the electric motor and the displacement of the pumps to optimize the operational efficiency of the crawler vehicle. In this way, it is possible to vary both the speed of the motor and the displacement of the pumps, so as to work at the point of maximum efficiency of the pumps while at the same time relatively guaranteeing the power requested by the specific operating requirements. In other words, the power supplied to the hydraulic motors is controlled by adjusting two mutually independent parameters (the speed of the electric motor and the displacement of the pumps) so as to reduce the energy consumption of the crawler vehicle and increase the duration of a battery assembly recharge.

By way of example, since the torque curve of the electric motor is substantially constant below a threshold value, it is possible to vary the speed of the electric motor below the threshold value to optimize the efficiency of one of the pumps while keeping the torque of the electric motor constant.

A further purpose of the present disclosure is to provide a computer program that reduces certain of the drawbacks of certain of the prior art. According to the present disclosure, a computer program configured to control a crawler vehicle is provided which is directly loadable into a memory of the computer to carry out the steps of the method described above when the program is run by the computer.

In accordance with the program, the method can be implemented relatively easily and economically.

In addition, the present disclosure relates to a program product comprising a readable medium on which the program is stored.

### BRIEF DESCRIPTION OF THE DRAWINGS

Further characteristics and advantages of the present disclosure will become clear from the following description of a non-limiting example of an embodiment made with reference to the appended drawings, wherein:

FIG. 1 is a side elevation view, with parts removed for clarity and parts shown schematically, of a crawler vehicle made according to the present disclosure;

FIG. 2 is a view from above, with parts removed for clarity, of the crawler vehicle of FIG. 1;

FIG. 3 is a block diagram of the crawler vehicle of FIG. 1; and

FIGS. 4 and 5 are graphs of the mechanical characteristics of respective components of the crawler vehicle of FIG. 1.

### DETAILED DESCRIPTION

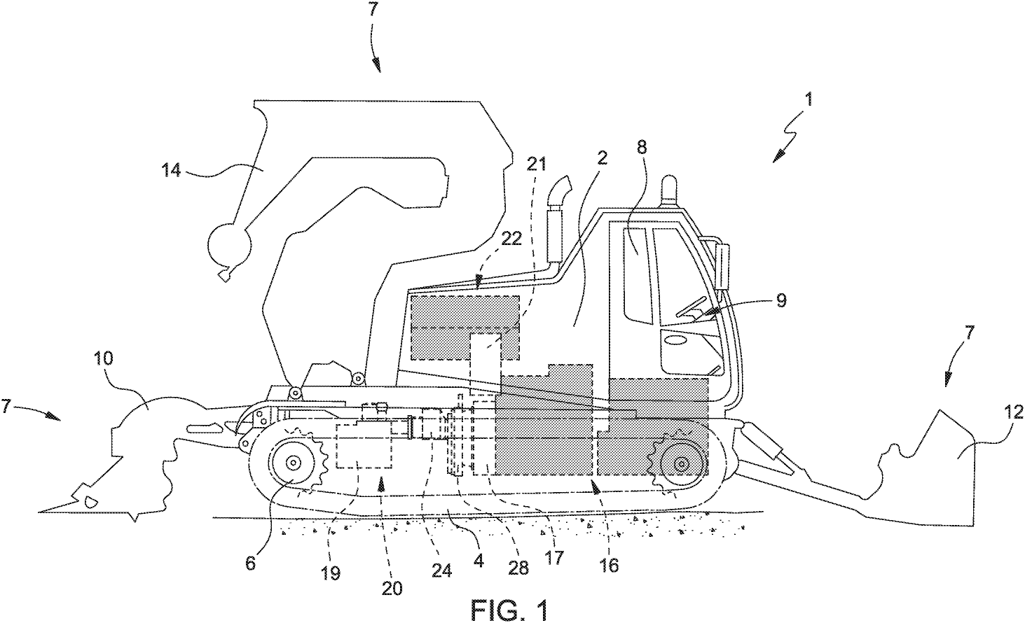

With reference to FIG. 1, reference numeral 1 globally denotes a crawler vehicle for the preparation of ski runs.

In particular, the crawler vehicle 1 is a snow groomer.

In greater detail, the crawler vehicle 1 is used for preparing alpine ski runs, and/or cross-country ski runs, and/or ski jumping ramps, and/or “half pipe”, and/or “snow-park” type ski runs.

According to a further embodiment, the crawler vehicle 1 may be used for operations in an agricultural context, such as for harvesting and/or handling agricultural products and/or for forage silage and/or for harvesting and/or handling bagasse.

Furthermore, according to a further embodiment, the crawler vehicle 1 comprises a cutter, in certain instances positioned on the front side of the vehicle, and which may be used for cutting vegetation.

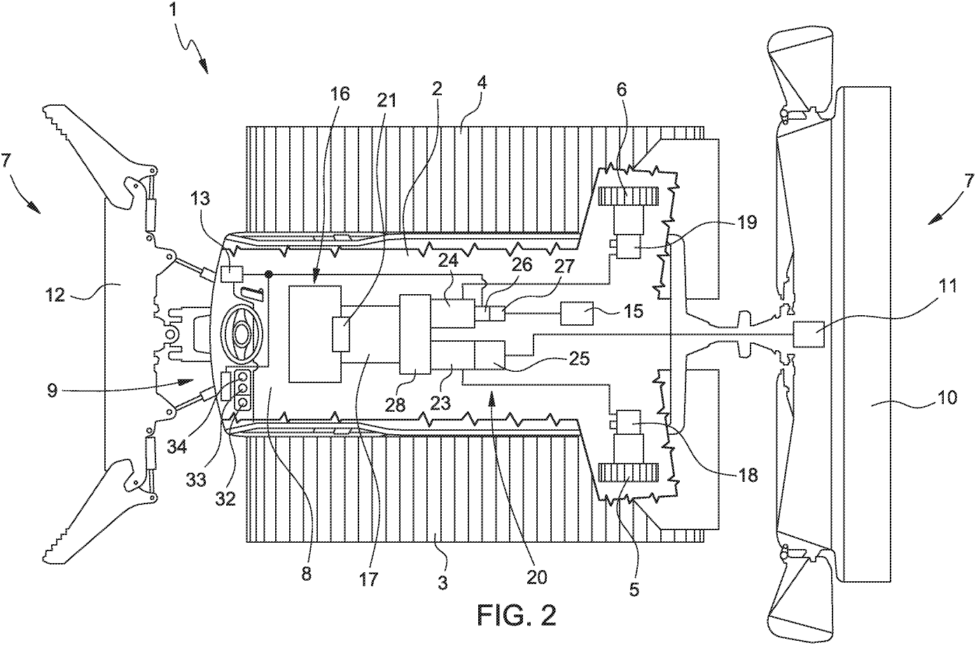

The crawler vehicle 1 comprises a frame 2; a track 3 (FIG. 2); a track 4; a drive wheel 5 (FIG. 2) and a drive wheel 6 independent of each other and coupled to the track 3 (FIG. 2) and the track 4, respectively; a plurality of hydraulically actuated tools 7 connected to the frame 2; a cabin 8 mounted on the frame 2; and a user interface 9 placed inside the cabin 8.

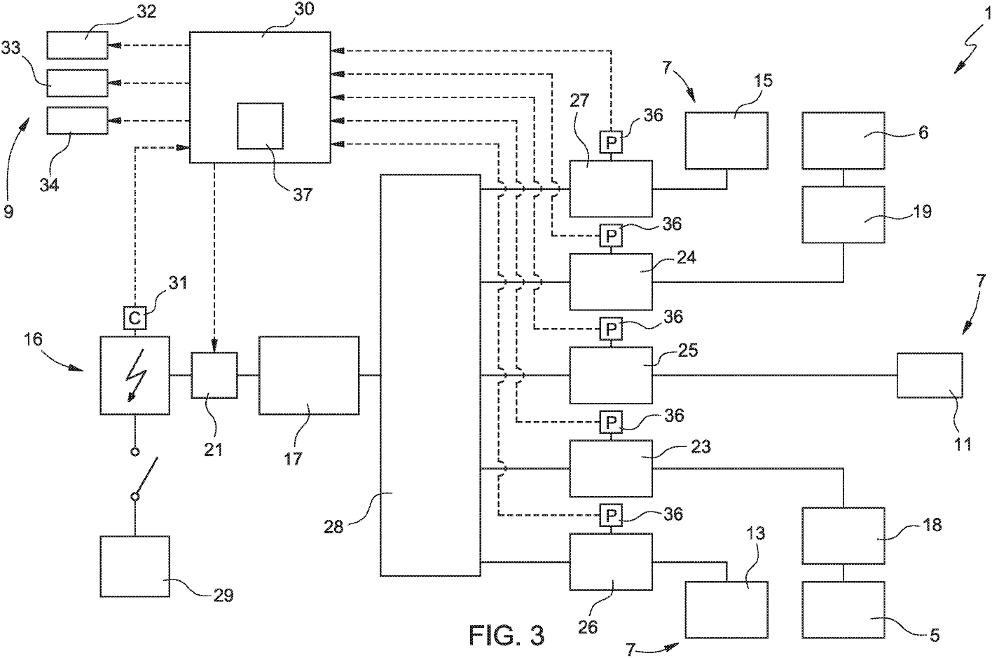

In the non-limiting case described and illustrated herein of the present disclosure, the tools 7 comprise a cutter 10 movably connected to the frame 2 and actuated by a hydraulic motor 11 (FIGS. 2 and 3), a shovel 12 movably connected to the frame 2 and actuated by a hydraulic motor 13 (FIGS. 2 and 3); and a winch 14 also movably connected to the frame 2 and actuated by a hydraulic motor 15 (FIGS. 2 and 3).

Within the scope of this description, the term “hydraulic motor” means any device for converting hydraulic power into mechanical power and encompasses within its meaning any type of hydraulic actuator and hydraulic cylinder.

According to one, non-limiting embodiment of the present disclosure, the cabin 8 is arranged at the front of the crawler vehicle 1 and faces the shovel 12. In such a configuration, the winch 14 is arranged at the rear of the crawler vehicle 1, behind the cabin 8.

The crawler vehicle 1 comprises a battery assembly 16 and an electric motor 17 powered by the battery assembly 16, which are mounted on the frame 2 behind the cabin 8 and predominantly under the cabin 8; two hydraulic motors 18 (FIGS. 2 and 3) and 19, which actuate the drive wheels 5 and 6, respectively; and a power transmission assembly 20, which connects the electric motor 17 to the hydraulic motors 18 (FIGS. 2 and 3) and 19 and to the tools 7, and is configured to transmit power from the electric motor 17 to the hydraulic motors 18 (FIGS. 2 and 3) and 19 and to the tools 7.

Each of the tools 7 may assume a plurality of positions relative to the frame 2. These positions are controlled and actuated by the hydraulic motors 11, 13 and 15 (FIGS. 2 and 3) via the power transmission assembly 20.

In addition, the crawler vehicle 1 comprises an inverter 21 configured to transmit electrical power from the battery assembly 16 to the electric motor 17; and a further battery assembly 22 placed behind the cabin 8 and above the electric motor 17 and the power transmission assembly 20.

The battery assembly 16 and the battery assembly 22 are detachably coupled to the crawler vehicle 1, such as via respective releasable coupling devices (not shown in the figures), so as to facilitate replacement of the battery assemblies 16 and 22.

In particular, the battery assembly 16 is removable from the front of the crawler vehicle 1. The battery assembly 22 is removable from the rear of the cabin 8.

According to an alternative embodiment (not shown in the figures), the battery assembly 16 is replaced by a power source external to the crawler vehicle 1, such as, for example, a cable configured to connect the electric motor 17 to the power grid or a pantograph power supply system.

With reference to FIGS. 2 and 3, the power transmission assembly 20 comprises five pumps 23, 24, 25, 26 and 27 mechanically connected to and powered by the electric motor 17.

In particular, the pump 23 is hydraulically connected to the hydraulic motor 18; pump 24 is hydraulically connected to the hydraulic motor 19; pump 25 is hydraulically connected to the hydraulic motor 11 of the cutter 10; pump 26 is hydraulically connected to the hydraulic motor 13 of the shovel 12; pump 27 is hydraulically connected to the hydraulic motor 15 of the winch 14.

In more detail, the hydraulic connection between each pump 23, 24, 25, 26 and 27 and the respective hydraulic motor 11, 13, 15, 18 and 19 is made possible by a respective hydraulic circuit in which the fluid for transmitting the hydraulic power flows.

In the case described and illustrated herein, the pumps 23, 24, 25, 26 and 27 are variable displacement pumps.

Moreover, the power transmission assembly 20 comprises a mechanical transmission 28, arranged between the electric motor 17 and the pumps 23, 24, 25, 26, and 27 and configured to transmit mechanical power from the electric motor 17 to the pumps 23, 24, 25, 26, and 27 and to distribute the power delivered by the electric motor 17 between the pumps 23, 24, 25, 26, and 27.

In addition, the crawler vehicle 1 comprises an auxiliary power assembly 29, which, according to various embodiments of the present disclosure, may include a fuel cell or internal combustion engine or an additional battery assembly.

According to one, non-limiting embodiment of the present disclosure, the auxiliary power supply assembly 29 is configured to charge the battery assembly 16 and /or the battery assembly 22 and is removable from the crawler vehicle 1.

With reference to FIG. 3, the crawler vehicle 1 comprises a control device 30 configured to control the power delivered by the electric motor 17.

In particular, the control device 30 is configured to optimize the power consumption of the electric motor 17.

The control device 30 comprises a charge sensor 31 configured to acquire the charge level of the battery assemblies 16 and/or 22. The control device 30 is configured to limit the power delivered by the electric motor 17 when the acquired charge level falls below a predetermined threshold.

The user interface 9 comprises an indicator 32 configured to emit a signal indicative of the charge level acquired by the charge sensor 31.

In addition, the control device 30 is configured to calculate and provide a remaining operating time of the crawler vehicle 1 based on the acquired charge level and on an expected average consumption of the crawler vehicle 1.

The user interface 9 comprises an indicator 33 configured to emit a signal indicative of the remaining operating time of the crawler vehicle 1.

In addition, the control device 30 is configured to acquire the GPS position of the crawler vehicle 1 and to link the acquired GPS position to a map, so as to determine, for example, the incline of the slope on which the crawler vehicle 1 is positioned.

The control device 30 is configured to calculate and provide a maximum operating distance based on the acquired charge level, on an expected average consumption of the crawler vehicle 1 and on at least one between the GPS position of the crawler vehicle 1, the snowpack characteristics of the ski slopes and the driving style of a crawler vehicle operator 1.

In more detail, the control device 30 is configured to use slope incline information derived from the GPS location of the crawler vehicle 1 to determine the energy consumption of the crawler vehicle 1 and to calculate the maximum operating distance of the crawler vehicle 1.

The user interface 9 comprises an indicator 34 configured to emit a signal indicative of the maximum forecast operating distance of the crawler vehicle 1.

In the case described and illustrated in FIG. 2, the user interface 9 is a graphic interface, such as a screen, configured to display indicators 32, 33 and 34 to inform an operator controlling the crawler vehicle 1.

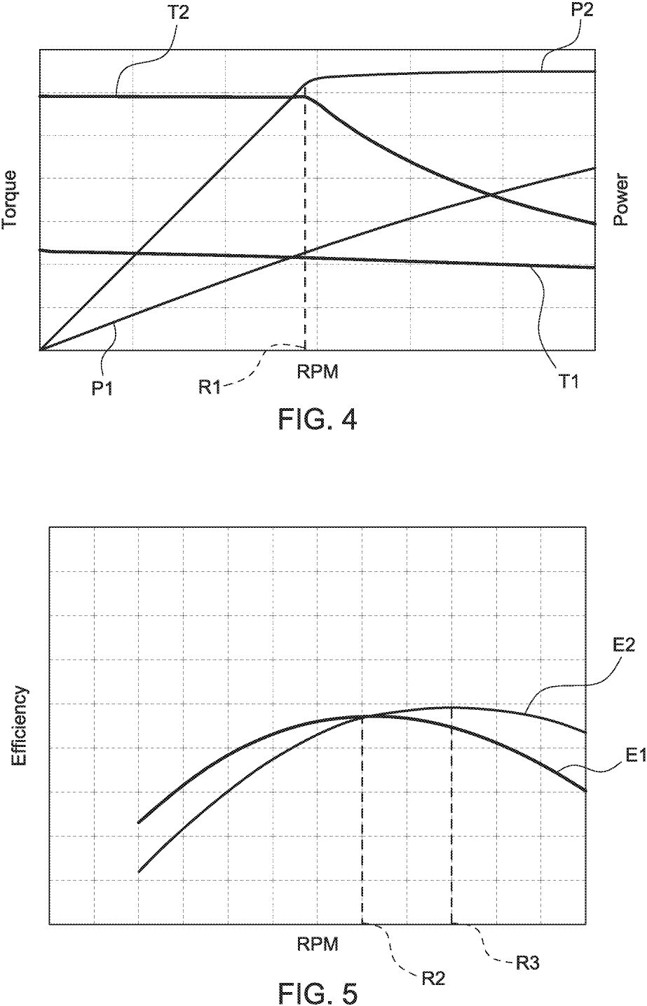

With reference to FIG. 4, a plot of torque curves T1 and T2 and power curves P1 and P2 as a function of the electric motor speed 17 is shown. The graph shows the typical relationships between the torque and the speed of the electric motor 17 and between the power and the speed of the electric motor 17.

In particular, the torque curve T1 and the power curve P1 show characteristic curves of the electric motor 17 under continuous operating conditions, while the torque curve T2 and the power curve P2 show characteristic curves of the electric motor 17 under peak operating conditions, which are utilizable only for a relatively short period of time.

The torque curve T1 is substantially constant as the speed of the electric motor 17 varies.

The power curve P1 increases in a substantially linear manner as the speed of the electric motor 17 increases.

The torque curve T2 is substantially constant below a speed threshold value R1 and decreases rapidly above a threshold value R1, as the speed of the electric motor 17 increases.

The power curve P2 increases in a substantially linear manner up to the speed threshold value R1, and remains substantially constant beyond the speed threshold value R1 as the speed of the electric motor 17 increases.

With reference to FIG. 5, a graph of efficiency curves E1 and E2 of one of the variable displacement pumps 23, 24, 25, 26 and 27 is shown as a function of pump speed 23, 24, 25, 26 or 27 for different pump displacement values 23, 24, 25, 26 or 27.

In particular, the efficiency curve E1 shows the efficiency of the pump 23, 24, 25, 26 or 27 as a function of the pump speed 23, 24, 25, 26 or 27 at a first pump displacement value 23, 24, 25, 26 or 27.

The efficiency curve E2 represents the efficiency of the pump 23, 24, 25, 26 or 27 as a function of pump speed 23, 24, 25, 26 or 27 at a second pump displacement value 23, 24, 25, 26 or 27.

The curves E1 and E2 have respective points of maximum efficiency at respective pump speed values R2 and R3 of the pump 23, 24, 25, 26 or 27.

The mechanical transmission 28 has a transmission ratio fixed between the rotation speed of the electric motor 17 and the rotation speed of each of the pumps 23, 24, 25, 26 and 27. In other words, the speed of the electric motor 17 is proportional to the speed of each of the pumps 23, 24, 25, 26 and 27.

The control device 30 is configured to independently control the speed of the electric motor 17 and the displacement of the pumps 23, 24, 25, 26 and 27 so as to optimize the operating efficiency of the crawler vehicle 1. In this way, it is possible to vary both the speed of the electric motor 17 and the displacement of the pumps 23, 24, 25, 26 and 27, so as to work at the point of maximum efficiency of the pumps 23, 24, 25, 26 and 27 while at the same time relatively guaranteeing the power request of the hydraulic motors 11, 13, 15, 18 and 19 in specific operating requirements.

By way of example, since the torque curves T1 and T2 are substantially constant below the threshold value R1, it is possible to vary the speed of the electric motor 17 below the threshold value R1 to enable the rotation of the pumps 23, 24, 25, 26 and 27 at the speed values R2, R3 corresponding to respective points of maximum efficiency, so as to optimize the efficiency of the pumps 23, 24, 25, 26 and 27 while keeping the torque of the electric motor 17 constant.

In particular, the control device 30 is configured to acquire the speed of the electric motor 17 and the displacement of the pumps 23, 24, 25, 26, 27 and to independently control the speed of the electric motor 17 and the displacement of the plurality of pumps 23, 24, 25, 26, 27 by respective closed-loop controls depending respectively on the acquired speed of the electric motor 17 and the acquired displacement of the plurality of pumps 23, 24, 25, 26, 27.

With reference to FIG. 3, the control device 30 comprises a plurality of hydraulic power sensors 35, each of which is configured to acquire a power signal correlated with a respective pump 23, 24, 25, 26, and 27. In particular, the control device 30 comprises a hydraulic power sensor 35 for each of the pumps 23, 24, 25, 26 and 27.

According to one, non-limiting embodiment of the present disclosure, each hydraulic power sensor 35 is a pressure sensor by virtue of the fact that in transmission, power is related to pressure.

The control device 30 is configured to acquire a requested hydraulic power from each hydraulic motor 11, 13, 15, 18, 19 to control the speed of the electric motor 17 and/or the displacement of the respective pump 23, 24, 25, 26, 27 to satisfy the requested hydraulic power; and to acquire the hydraulic power transmitted to each hydraulic motor 11, 13, 15, 18, 19 by the hydraulic power sensors 35.

From an operating point of view, the requested hydraulic power is the product of a requested torque, determined by pressure acquisition using pressure sensors 35 in the hydraulic circuit of the power transmission assembly 20, and a requested speed, determined, by way of example, by the position of an acceleration pedal controlled by an operator of the crawler vehicle 1.

The requested power is then calculated as a function of the pressure values acquired and related to the requested torque and the requested speed values.

Once the power request has been calculated, the electric motor 17 must deliver the power necessary to meet the power request, within the limits of the maximum power of the electric motor 17.

The delivery of the requested power is modulated by varying two parameters: the speed of the electric motor 17; and the displacement of the pump 23. These parameters are selected so as to optimize the efficiency of the electric motor 17 and the pump 23. Although these considerations apply to each of pumps 23, 24, 25, 26, and 27, for simplicity of discussion, only pump 23 is considered.

In the case described herein, the control device 30 is configured to acquire a requested running speed of the crawler vehicle 1, for example the position of an accelerator device such as an acceleration pedal; control the speed of the electric motor 17 and/or the displacement of the pumps 23 and 24 to substantially match the requested running speed.

As a further control, the acquisition of the running speed of the crawler vehicle 1 and its comparison with the requested running speed is envisaged.

In addition, the control device 30 comprises a computer 36, which comprises a memory containing a program for controlling the crawler vehicle 1 and is configured to run the program.

The computer 36 can be programmed directly or is configured to read program media via special interfaces.

In use and with reference to FIG. 3, the control device 30 controls the crawler vehicle 1 both when the crawler vehicle 1 is running and in operations related to the use of the tools 7 so as to optimize the energy consumption of the crawler vehicle 1.

In particular, the control device 30 controls the speed of the electric motor 17 and the displacement of the pumps 23, 24, 25, 26 and 27, so as to drive the pumps 23, 24, 25, 26 and 27 around the maximum efficiency points R2, R3 (FIG. 5).

In more detail, in the event that the position of the crawler vehicle 1 needs to be varied, an operator of the crawler vehicle 1, for example by operating an acceleration pedal, determines the requested running speed of the crawler vehicle 1. The control device 30 acquires the requested torque by the pressure sensors 35 and the requested running speed and determines the hydraulic power requested of the hydraulic motors 18 and 19. The requested torque is an effect of the conditions under which the crawler vehicle operates 1. By way of example, in the case of advancing up a slope, the requested torque is determined by the force of gravity to be counteracted acting on the crawler vehicle 1.

Subsequently, the control device 30 controls the speed of the electric motor 17 and/or the displacement of the pumps 23 and 24 to meet the requested hydraulic power and so as to drive the pumps 23 and 24 around the point of maximum efficiency R2, R3 (FIG. 5).

The hydraulic power transmitted by the pumps 23 and 24 to the hydraulic motors 18 and 19 is determined via the hydraulic power sensors 35 and acquired by the control device 30 so as to control the hydraulic power transmitted via a first closed loop.

In addition, the control device 30 controls the speed of the electric motor 17 and/or the displacement of the pumps 23 and 24 to substantially match the requested running speed, and acquires the running speed of the crawler vehicle 1, so as to control the running speed of the crawler vehicle 1 via a second closed loop.

In more detail, the first closed loop is internal with respect to the second closed loop.

Although control methods of the power transmitted to the hydraulic motors 18 and 19 and the running speed of the crawler vehicle 1 have been described, the same control methods also apply to controlling the power transmitted to the hydraulic motors 11, 13 and 15 and the rotational speed thereof.

It is evident that variations may be made to the present disclosure while remaining within the scope of protection of the appended claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention claimed is:

1-21. (canceled)

22. A crawler vehicle comprising:
a frame;
a cabin mounted on the frame;
a first drive wheel driven by a first hydraulic motor;
a second drive wheel driven by a second hydraulic motor;
a battery assembly mounted on the frame behind the cabin, a majority of the battery assembly being located under the cabin;
an electric motor configured to be electrically powered by the battery assembly and mounted on the frame behind the cabin, a majority of the electric motor being located under the cabin; and
a power transmission assembly configured to transmit power from the electric motor to the first hydraulic motor and to the second hydraulic motor.

23. The crawler vehicle of claim 22, further comprising a tool moveably connected to the frame and actuatable by a third hydraulic motor.

24. The crawler vehicle of claim 23, wherein the power transmission assembly comprises:
a first variable displacement pump hydraulically connected to the first hydraulic motor;
a second variable displacement pump hydraulically connected to the second hydraulic motor;
a third variable displacement pump hydraulically connected to the third hydraulic motor; and
a mechanical transmission placed between the electric motor and the first, second and third variable displacement pumps, the mechanical transmission being configured to distribute the power supplied by the electric motor between the first, second and third variable displacement pumps.

25. The crawler vehicle of claim 24, further comprising a control device configured to control the power supplied by the electric motor.

26. The crawler vehicle of claim 25, wherein the control device is configured to independently control a speed of the electric motor and a respective displacement of the variable displacement pumps to optimize an operational efficiency of the crawler vehicle.

27. The crawler vehicle of claim 26, wherein the control device is configured to:
acquire the speed of the electric motor;
acquire the displacement of each of the variable displacement pumps; and
control the speed of the electric motor and the respective displacement of the variable displacement pumps by respective closed loop controls based on the acquired speed of the electric motor and the respective acquired displacement of the variable displacement pumps.

28. The crawler vehicle of claim 26, wherein the control device is configured to:
acquire a requested hydraulic power to each hydraulic motor; and
control at least one of the speed of the electric motor and the respective displacement of the variable displacement pumps to satisfy the requested hydraulic power.

29. The crawler vehicle of claim 28, the control device is configured to:
acquire a requested running speed of the crawler vehicle; and
control at least one of the speed of the electric motor and the respective displacement of the variable displacement pumps to substantially match the requested running speed.

30. The crawler vehicle of claim 25, wherein the control device comprises a charge sensor configured to acquire a charge level of the battery assembly, the control device being configured to limit a power output of the electric motor when the acquired charge level is below a predetermined threshold.

31. The crawler vehicle of claim 30, wherein the control device is configured to calculate a remaining operating time of the crawler vehicle based on the acquired charge level and an expected average consumption of the crawler vehicle.

32. The crawler vehicle of claim 30, wherein the control device is configured to calculate a maximum operating distance based on at least one of: the acquired charge level, an expected average consumption of the crawler vehicle and at least one of a GPS position of the crawler vehicle, a snowpack characteristic of a ski slope and a driving style of a crawler vehicle operator.

33. The crawler vehicle of claim 22, further comprising an inverter configured to transmit electric power from the battery assembly to the electric motor.

34. The crawler vehicle of claim 22, further comprising an auxiliary power supply assembly comprising at least one of a fuel cell, an internal combustion engine and a further battery assembly.

35. The crawler vehicle of claim 34, wherein the auxiliary power supply assembly is configured to charge the battery assembly and is removable from the crawler vehicle.

36. The crawler vehicle of claim 22, wherein the battery assembly is removably coupled to the crawler vehicle to facilitate a replacement of the battery assembly.

37. A method of controlling a crawler vehicle comprising a frame, a first drive wheel driven by a first hydraulic motor, a second drive wheel driven by a second hydraulic motor, and a tool connected to the frame and actuatable by a third hydraulic motor, the method comprising:
independently controlling a speed of an electric motor of the crawler vehicle and a respective displacement of a plurality of variable displacement pumps of a power transmission assembly of the crawler vehicle to optimize an operational efficiency of the crawler vehicle, wherein the electric motor is powered by a battery assembly of the crawler vehicle and the power transmission assembly is configured to transmit power from the electric motor to the first hydraulic motor, the second hydraulic motor and the third hydraulic motor.

38. The method of claim 37, further comprising:
acquiring the speed of the electric motor, and
acquiring the respective displacement of the variable displacement pumps, wherein the independent control of the speed of the electric motor and the respective displacement of the plurality of variable displacement pumps is carried out by respective closed-loop controls based on the acquired speed of the electric motor and the respective acquired displacement of each of the plurality of variable displacement pumps.

39. The method of claim 37, further comprising:
acquiring a requested hydraulic power to each hydraulic motor; and
controlling at least one of the speed of the electric motor and the respective displacement of the plurality of variable displacement pumps to satisfy the requested hydraulic power.

40. The method of claim 39, further comprising:
acquiring a requested running speed of the crawler vehicle; and
controlling at least one of the speed of the electric motor and the respective displacement of the variable displacement pumps to substantially match the requested running speed.

41. A non-transitory computer-readable medium that stores a plurality of instructions that, when executed by a control device of a crawler vehicle comprising a frame, a first drive wheel driven by a first hydraulic motor, a second drive wheel driven by a second hydraulic motor, and a tool connected to the frame and actuatable by a third hydraulic motor, cause the control device to:
independently control a speed of an electric motor of the crawler vehicle and a respective displacement of a plurality of variable displacement pumps of a power transmission assembly of the crawler vehicle to optimize an operational efficiency of the crawler vehicle, wherein the electric motor is powered by a battery assembly of the crawler vehicle and the power transmission assembly is configured to transmit power from the electric motor to the first hydraulic motor, the second hydraulic motor and the third hydraulic motor.
